(19) United States
(12) Patent Application Publication
(10) Pub. No.: US 2024/0028635 A1
(43) Pub. Date: Jan. 25, 2024

(54) PLAYBACK CONTROL METHOD AND APPARATUS, ELECTRONIC DEVICE, AND COMPUTER-READABLE STORAGE MEDIUM

(71) Applicant: BEIJING BYTEDANCE NETWORK TECHNOLONGY CO., LTD., BEIJING (CN)

(72) Inventor: Suiyu FENG, BEIJING (CN)

(21) Appl. No.: 18/043,875

(22) PCT Filed: Aug. 31, 2021
(86) PCT No.: PCT/CN2021/115665

§ 371 Date: Mar. 2, 2023

(30) Foreign Application Priority Data
Sep. 2, 2020 (CN) 202010908691.0

(51) Int. Cl. G06F 16/44; G06F 16/438

(52) U.S. Cl. CPC G06F 16/44; G06F 16/4393

(57) ABSTRACT

Provided are a playback control method and apparatus, an electronic device, and a computer-readable storage medium. The playback control method includes: displaying a record analog image of a multi-media file in a playback process of the multi-media file, wherein the record analog image has a sound groove pattern; and displaying a marker of a playback progress of the multi-media file on the sound groove pattern according to the playback progress of the multi-media file, where a location of the marker on the sound groove pattern is configured for reflecting the playback progress.

This application claims priority to Chinese patent application No. 202010908691.0 filed with the China National Intellectual Property Administration (CNIPA) on Sep. 2, 2020, the disclosure of which is incorporated herein by reference in its entirety.

### TECHNICAL FIELD

The present application relates to the field of multi-media file playback technologies, for example, a playback control method and apparatus, an electronic device, and a computer-readable storage medium.

### BACKGROUND

When a multi-media file is played, a current playback node is usually marked at a progression bar to display the playback progress of the multi-media file. In a case of the playback of a high-quality multi-media file or some special playback modes (such as a playback mode in which the sound effect of a phonograph record can be simulated), a user can obtain better hearing experience. Meanwhile, user requirements about the visual experience of the information displayed in the process of the playback of the multi-media file also increase. However, the information that the progression bar can present is very limited, and a mismatch between the visual experience that the progression bar brings about and the high-quality hearing experience that the user obtains is produced, affecting the playback effect of the multi-media file to some extent.

Therefore, how to further improve the playback effect of the multi-media file becomes a technical problem to be solved urgently at present.

### SUMMARY

Embodiments of the present application provide a playback control method and apparatus, an electronic device, and a computer-readable storage medium to improve the situation in which the poor playback effect of a multi-media file exists in the related art.

In a first aspect, embodiments of the present application provide a playback control method. The method includes the following steps: a record analog image of a multi-media file is displayed in the playback process of the multi-media file, where the record analog image has a sound groove pattern; and a marker of a playback progress of the multi-media file is displayed on the sound groove pattern according to the playback progress of the multi-media file, where the location of the marker on the sound groove pattern is configured for reflecting the playback progress.

In a second aspect, embodiments of the present application provide a playback control apparatus. The apparatus includes: a record analog image display unit, which is configured to display a record analog image of a multi-media file in a playback process of the multi-media file, where the record analog image has a sound groove pattern; and a playback progress marker display unit, which is configured to display a marker of a playback progress of the multi-media file on the sound groove pattern according to the playback progress of the multi-media file, where a location of the marker on the sound groove pattern is configured for reflecting the playback progress.

In a third aspect, embodiments of the present application provide an electronic device. The electronic device includes at least one processor and a memory communicatively connected to the at least one processor, where the memory has instructions executable by the at least one processor stored thereon, and the instructions are used for performing the method described in the first aspect.

In a fourth aspect, embodiments of the present application provide a computer-readable storage medium having computer-executable instructions stored thereon, where the computer-executable instructions are used for performing the method flow described in the first aspect.

### BRIEF DESCRIPTION OF DRAWINGS

To illustrate the technical solutions in the embodiments of the present application more clearly, the drawings used in the embodiments will be briefly described below.

FIG. 1 illustrates a flowchart of a playback control method according to an embodiment of the present application;

FIG. 2 illustrates a schematic diagram of an analog sound waveform according to an embodiment of the present application;

FIG. 3 illustrates a flowchart of a playback control method according to another embodiment of the present application;

FIG. 4 illustrates a flowchart of a playback control method according to yet another embodiment of the present application;

FIG. 5 illustrates a schematic diagram of an analog sound waveform and a tone arm according to an embodiment of the present application;

FIG. 6 illustrates a block diagram of a playback control apparatus according to an embodiment of the present application; and

FIG. 7 illustrates a block diagram of an electronic device according to an embodiment of the present application.

### DETAILED DESCRIPTION

For a better understanding of the technical solutions of the present application, embodiments of the present application are described below in detail in conjunction with the drawings.

It is to be noted that the described embodiments are part, not all, of embodiments of the present application. Based on the embodiments described herein, all other embodiments obtained by those of ordinary skill in the art without creative work are within the scope of the present application.

Terms used herein are for the purpose of describing specific embodiments only and are not intended to be limiting of the present application. Unless otherwise expressly indicated by the context, singular forms “a”, “an” and “the” used in embodiments and the appended claims of the present application are intended to include plural forms.

The following embodiments of the present application are suitable for clients with audio and video playback functions.

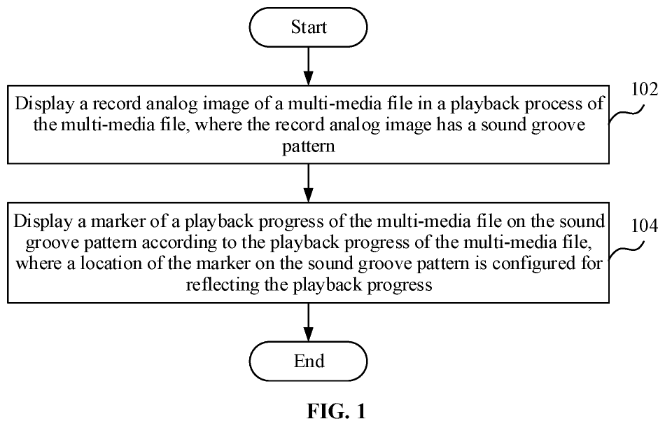

FIG. 1 illustrates a flowchart of a playback control method according to an embodiment of the present application.

As shown in FIG. 1, the flow of the playback control method according to an embodiment of the present application includes steps 102 and 104.

In step 102, a record analog image of a multi-media file is displayed in the playback process of the multi-media file, where the record analog image has a sound groove pattern.

In step 104, a marker of a playback progress of the multi-media file is displayed on the sound groove pattern according to the playback progress of the multi-media file, where the location of the marker on the sound groove pattern is configured for reflecting the playback progress.

The playback progress of the multi-media file refers to the location at which the multi-media file is currently played. Since the sound groove pattern in the record analog image is generated by mapping the audio waveform of the multi-media file, any location in the sound groove pattern corresponds to a location on the audio waveform of the multi-media file. Therefore, a marker may be displayed at the location to which the multi-media file is currently played, that is, at the playback progress of the multi-media file, the marker is a marker of the playback progress, and the location of the marker on the sound groove pattern may reflect the playback progress of the multi-media file.

In the preceding technical solution, anew information display manner is provided for the problem that the playback effect of the multi-media file is poor due to the limited information displayed on the progression bar in the related art. In the manner, a record analog image having a sound groove pattern can be displayed in the process of playing the multi-media file.

The sound groove pattern is obtained by mapping an audio waveform of the multi-media file onto a groove track and is displayed in a manner of an analog sound waveform.

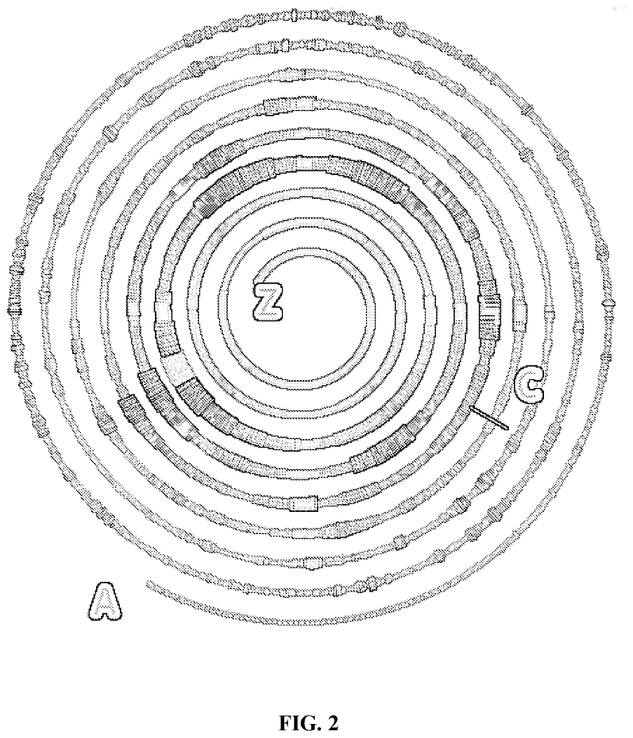

The analog sound waveform is obtained from the audio waveform of the multi-media file, and for example, the analog sound waveform is obtained by compressing the audio waveform of the multi-media file. With reference to FIG. 2, A and Z denote a start playback node and a stop playback node of the multi-media file, respectively. In this manner, the scheme of reflecting the playback progress through a playback progress bar in the related art is replaced with the scheme of displaying the playback progress through a marker on the record analog image. In the playback process of the multi-media file, compared with the change in the playback progress bar, the change in the marker of the playback progress on the record analog image can display the multi-media file more accurately, richly and vividly so that the user can obtain high-quality visual experience while obtaining sufficient hearing experience, thereby improving the overall experience of the user in the multimedia playback process.

In one embodiment, the record analog image having the sound groove pattern may be displayed on the audio and video playback interface of a client.

In another embodiment, the record analog image having the sound groove pattern may be displayed in a floating window of any functional interface of a client.

The following is described using an example where the playback content of the multi-media file is a song (in particular, a popular song). The form of popular songs often includes a chorus which is the climax of the whole song, and the performer often needs to raise his volume when singing the chorus. The amplitude of the audio waveform of the multi-media file reflects the magnitude of the volume, and therefore, for the song including a chorus, the amplitude of the audio waveform of the multi-media file in the chorus is overall larger than other portions.

For example, assuming that a multi-media file includes verse, chorus, verse, and chorus in sequence, the volume of the verse is moderate so that the amplitude of the analog sound waveform corresponding to the verse is relatively smaller, and the volume of the chorus is high so that the amplitude of the analog sound waveform corresponding to the chorus is relatively larger. Therefore, in the record analog image of the multi-media file, the analog sound waveform is divided into four distinct sections from outside to inside: the first section with overall low amplitude, the second section with overall high amplitude, the third section with overall low amplitude, and the fourth section with overall high amplitude, and these four sections correspond to the verse, chorus, verse, and chorus, respectively.

For example, assuming that a multi-media file includes verse, chorus, and verse in sequence, the volume of the verse is high so that the amplitude of the analog sound waveform corresponding to the verse is relatively larger, and the volume of the chorus is moderate so that the amplitude of the analog sound waveform corresponding to the chorus is relatively smaller. Therefore, in the record analog image of the multi-media file, the analog sound waveform is divided into three distinct sections from outside to inside: the first section with overall high amplitude, the second section with overall low amplitude, and the third section with overall high amplitude.

In this manner, the user can identify the connection locations of the four sections of analog voice waveform, that is, the exact switching location or the approximate switching location of the verse and the chorus.

For example, after the user knows the exact switching location or the approximate switching location of each section of verse and each section of chorus, the user can perform a playback control operation and accurately select the required playback node. This technical solution is described in detail in embodiments described below.

Before step 102, a record analog image having a sound groove pattern is required to be obtained, and the record analog image may be obtained in a variety of manners which include, but are not limited to, several manners described below.

In one embodiment, the record analog image having a sound groove pattern corresponding to the multi-media file may be acquired at a first designated storage location.

The multi-media file is generally downloaded or cached by the client from the server via the network, and the multi-media file may be an online file or an offline file. For the multi-media file with high downloading times or high caching times, such as popular songs and mobile phone ringtones, a record analog image having a sound groove pattern may be generated for the multi-media file, and the record analog image may be stored at the first designated storage location. The first designated storage location may be located in a server, a client or any other storage space.

That is, when the client plays a multi-media file, the client may acquire the record analog image which corresponds to the multi-media file and which is stored in the server or any other storage space and display the record analog image. Alternatively, when the client downloads or caches a multi-media file, the record analog image corresponding to the multi-media file is downloaded or cached to the client. Thus, when the client plays the multi-media file, the client may obtain the record analog image which corresponds to the multi-media file and which is stored in the client itself and display the record analog image.

In another embodiment, an audio waveform of the multi-media file is acquired, a sound groove track of the sound groove pattern on the record analog image is determined, and the audio waveform of the multi-media file is mapped onto the sound groove track to obtain the sound groove pattern.

In other words, the playback duration of the multi-media file has a mapping relationship with the length of the analog sound waveform, and the audio waveform of the multi-media file is mapped onto the sound groove track on the record analog image so that each node in the audio waveform corresponds to a respective node of the sound groove pattern.

In one embodiment, the length of the sound groove pattern in all the record analog images may be set to a first designated length.

In another embodiment, multiple playback length ranges may be set, and a corresponding designated length may be set for each playback length range. For example, the length of the sound groove pattern corresponding to a multi-media file whose playback duration is in the range of 0 to 6 min is set to the first designated length, and the length of the sound groove pattern corresponding to a multi-media file whose playback duration is in the range of 6 min and above is set to a second designated length, where the second designated length is greater than the first designated length.

The sound groove pattern having a designated length has a certain mapping relationship with the playback duration of the multi-media file, and for example, the first ⅙ of the length of the sound groove pattern corresponds to the first ⅙ of the playback duration of the multi-media file. In other words, the location interval on the sound groove pattern corresponds to the playback node interval of the multi-media file. The higher the tone, the denser the corresponding waveform, and the larger the volume, the higher the amplitude of the corresponding waveform.

In another embodiment, an image rendering parameter corresponding to the multi-media file is acquired from a second designated storage location, and the record analog image having a sound groove pattern is rendered for the multi-media file based on the image rendering parameter.

For the multi-media file with high downloading times or high caching times, such as popular songs and mobile phone ringtones, an image rendering parameter required for rendering the sound groove pattern of the record analog image may be generated for such a multi-media file. When the client plays the multi-media file, the client may acquire the image rendering parameter corresponding to the multi-media file, perform rendering based on the image rendering parameter to obtain the record analog image having a sound groove pattern, and display the record analog image.

The image rendering parameter is stored at the second designated storage location, and the second designated storage location may be located in a server, a client or any other storage space.

The image rendering parameter is smaller in volume and occupies less storage space than the record analog image having a sound groove pattern, thereby saving storage space. Meanwhile, the system resources occupied by the client to download or cache the image rendering parameter are fewer, and the download speed or cache speed is relatively improved, thereby improving the user experience.

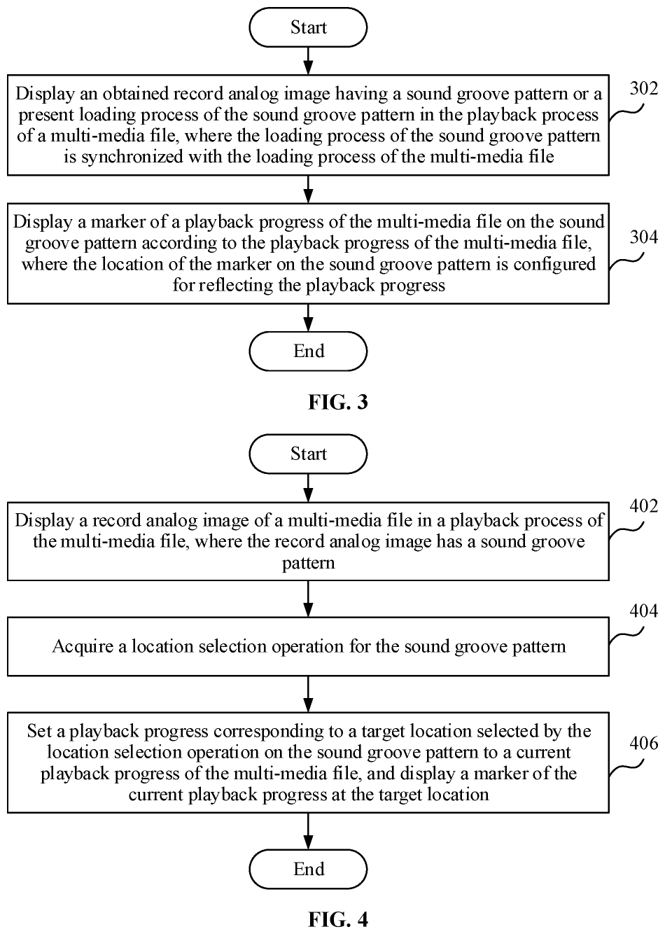

On the basis of the preceding embodiments, FIG. 3 illustrates a flowchart of a playback control method according to another embodiment of the present application.

As shown in FIG. 3, the flow of the playback control method according to another embodiment of the present application includes steps 302 and 304.

In step 302, the obtained record analog image having the sound groove pattern is displayed or a loading process of the sound groove pattern is displayed in the playback process of the multi-media file, where the loading process of the sound groove pattern is synchronized with the loading process of the multi-media file.

In step 304, a marker of a playback progress of the multi-media file is displayed on the sound groove pattern according to the playback progress of the multi-media file, where the location of the marker on the sound groove pattern is configured for reflecting the playback progress.

The obtained record analog image having the sound groove pattern is displayed directly, that is, the audio information of the multi-media file is displayed to the user quickly and intuitively by directly displaying the analog sound waveform so that the user can quickly and intuitively know the content of the multi-media file.

In both the manner of mapping the audio waveform of the multi-media file onto the sound groove track and the manner based on the image rendering parameter, the record analog image having the sound groove pattern is generated gradually from the start point to the end point of the sound groove pattern. Therefore, for the loading process of the sound groove image, reference may be made to the generation process of the sound groove pattern.

For example, the loading process of the sound groove image is displayed in the following manner: the sound groove pattern is increased from outside to inside or from inside to outside in circles until the complete analog sound waveform is generated. Therefore, the visual experience of the user is improved.

For example, the displaying of the loading process of the record analog image may be synchronized with the decoding process of the multi-media file. For example, when it takes 8 s to decode a 5 min song, the analog sound waveform is gradually displayed from outside to inside within the time of 8 s for decoding the song, thereby improving the visual experience of the user. For example, different parts of the multi-media file are displayed in different colors.

In one embodiment, analog sound waveforms of the verse, chorus, hook and other parts may be set to corresponding colors, respectively, so that the user can determine the locations of different audio contents based on the colors of the analog sound waveforms.

It is to be added that in one embodiment, the multi-media file may be played through multiple channels, and the corresponding analog sound waveform may be drawn for the audio information played through each channel. Generally, when the display space in the terminal is limited, a channel switching option may be set, and a different channel may be selected to obtain the analog sound waveform corresponding to the channel. Therefore, the user can read the multi-media file in richer and more vivid manners.

On the basis of the preceding embodiments, FIG. 4 illustrates a flowchart of a playback control method according to yet another embodiment of the present application.

As shown in FIG. 4, the flow of the playback control method according to yet another embodiment of the present application includes steps 402, 404 and 406.

In step 402, a record analog image of a multi-media file is displayed in the playback process of the multi-media file, where the record analog image has a sound groove pattern.

In step 404, a location selection operation for the sound groove pattern is acquired.

The location selection operation for the sound groove pattern refers to the operation in which the user selects a location on the sound groove pattern. Since the sound groove pattern is obtained by mapping the audio waveform of the multi-media file onto the sound groove track, the location selected by the user in the location selection operation corresponds to a certain location on the audio waveform of the multi-media file.

In step 406, a playback progress corresponding to a target location selected by the location selection operation on the sound groove pattern is set to a current playback progress of the multi-media file, and a marker of the current playback progress is displayed at the target location.

Since the target location selected by the user in the location selection operation corresponds to a certain location on the audio waveform of the multi-media file, the location on the audio waveform of the multi-media file may be directly determined as the location corresponding to the current playback progress. Therefore, the user can set the current playback progress according to actual demands, thereby improving the accuracy and effectiveness of the playback control.

The marker of the playback progress may be displayed on the sound groove pattern for the first time according to the playback progress of the multi-media file before step 404 or may be displayed for the first time when the marker is set at the target location in step 406.

In one embodiment, the marker of the playback progress is dynamically displayed on the sound groove pattern while playing the multi-media file, where the marker includes a stylus pattern or a pickup pattern.

With reference to FIG. 2, the location of the stylus pattern is marked at C, and the location of the stylus pattern is the location corresponding to the current playback progress of the multi-media file. With the playback of the multi-media file, the current playback progress changes, and the stylus pattern rotates accordingly and always points to the location corresponding to the current playback progress. Therefore, the change in the playback progress is vividly displayed in combination with the analog sound waveform image, thereby improving the visual experience of the user.

Of course, the marker of the playback progress includes, but is not limited to, a stylus pattern or a pickup pattern, and may also include any pattern capable of displaying the current playback progress.

In one embodiment, a rotational speed setting operation for the marker is acquired, and the step in which the marker of the playback progress is dynamically displayed on the sound groove pattern includes the following step: the marker of the playback progress is dynamically displayed on the sound groove pattern according to a rotational speed set by the rotational speed setting operation, where the rotational speed corresponds to a playback speed of the multi-media file.

Since the playback speed of the multi-media file corresponds to the rotational speed of the marker of the playback progress on the analog sound waveform, the playback speed of the multi-media file can be changed by adjusting the rotational speed of the marker of the playback progress on the analog sound waveform.

For example, multiple rotational speed options may be provided for the user to select. When the user selects one rotational speed, the client uses the playback speed corresponding to the rotational speed to play the multi-media file. The playback speed is changed by setting the rotational speed of the marker of the playback progress so that the user can obtain the same experience as using the physical record player, thereby improving the user experience.

In addition, since the analog sound waveforms of the verse, chorus, hook and the like may be set to their respective colors, the user can select the playback node by moving the marker of the playback progress to the locations where different colors are selected.

For example, when the marker includes a stylus pattern, a tone arm pattern is dynamically displayed while displaying the record analog image, where the tone arm pattern is connected to the stylus pattern, and the stylus pattern is always located at the target location corresponding to the current playback progress of the multi-media file on the sound groove pattern in the dynamic displaying process of the stylus pattern.

Through the joint displaying of the tone arm pattern and the stylus pattern, the user can obtain the same experience as using the physical record player, thereby improving the visual experience of the user.

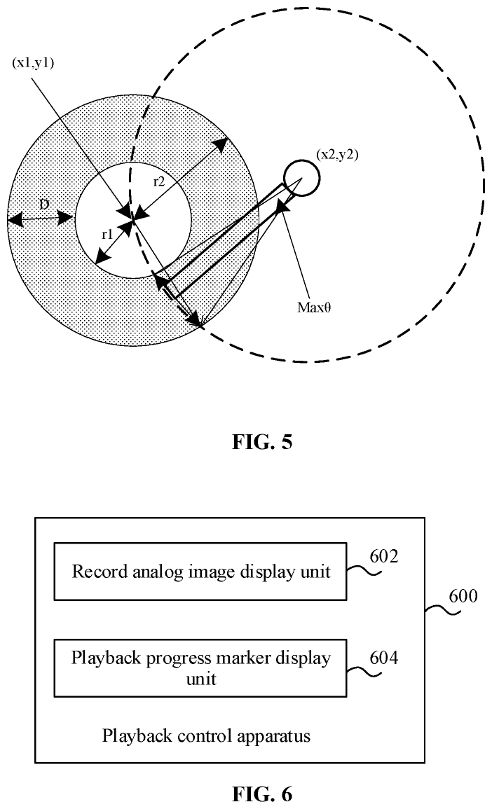

With reference to FIG. 5, in the same coordinate system, the tone arm and the innermost and outermost circles of the analog sound waveform are exemplarily drawn with the coordinates of the center of the circle of the analog sound waveform as (x1, y1) and the coordinates of the axis of the tone arm as (x2, y2). For any two adjacent circles, the radius of the inner circle is r1, the radius of the outer circle is r2, the distance from the outer circle to the outer circle is D=r2−r1.

The rotational speed of the stylus pattern is set to 60 rpm, that is, 60 circles/min or 1 circle per second.

If the total number of circles of the analog sound waveform is R=60 and a song with the duration of T=60 s is played, the stylus pattern needs to rotate 60 times, that is, every one second, the stylus pattern turns a circle from outside to inside. In this manner, the playback duration consumed on the circle C is t, and t=T/R.

Therefore, every T/R seconds, the tone arm rotates from the outer circle to the inner circle, the rotation angle is θ, and θ=1/Max θ.

FIG. 6 illustrates a block diagram of a playback control apparatus according to an embodiment of the present application.

As shown in FIG. 6, the playback control apparatus 600 according to an embodiment of the present application includes a record analog image display unit 602 and a playback progress marker display unit 604. The record analog image display unit 602 is configured to display a record analog image of a multi-media file in the playback process of the multi-media file, where the record analog image has a sound groove pattern. The playback progress marker display unit 604 is configured to display a marker of a playback progress of the multi-media file on the sound groove pattern according to the playback progress of the multi-media file, where a location of the marker on the sound groove pattern is configured for reflecting the playback progress.

On the basis of the preceding embodiments of the present application, the sound groove pattern is obtained by mapping an audio waveform of the multi-media file onto a sound groove track.

In the preceding embodiments of the present application, for example, the apparatus further includes a location selection operation acquisition unit and a playback progress control unit. The location selection operation acquisition unit is configured to acquire a location selection operation for the sound groove pattern. The playback progress control unit is configured to set a playback progress corresponding to a target location selected by the location selection operation on the sound groove pattern to a current playback progress of the multi-media file, and display a marker of the current playback progress at the target location.

In the preceding embodiments of the present application, for example, the record analog image display unit 602 is configured to display the obtained record analog image having the sound groove pattern or display a loading process of the sound groove pattern, where the loading process of the sound groove pattern is synchronized with the loading process of the multi-media file.

In the preceding embodiments of the present application, for example, the playback progress marker display unit 604 is configured to dynamically display the marker of the playback progress on the sound groove pattern while playing the multi-media file, where the marker includes a stylus pattern or a pickup pattern.

In the preceding embodiments of the present application, for example, the apparatus further includes a rotational speed setting operation acquisition unit. The rotational speed setting operation acquisition unit is configured to acquire a rotational speed setting operation for the marker. The playback progress marker display unit 604 is configured to dynamically display the marker of the playback progress on the sound groove pattern according to a rotational speed set by the rotational speed setting operation, where the rotational speed corresponds to a playback speed of the multi-media file.

In the preceding embodiments of the present application, for example, the apparatus further includes a tone arm pattern display unit. The tone arm pattern display unit is configured to, when the marker includes the stylus pattern, dynamically display a tone arm pattern while displaying the record analog image, where the tone arm pattern is connected to the stylus pattern, and the stylus pattern is always located at the target location corresponding to the current playback progress of the multi-media file on the sound groove pattern in the dynamic displaying process of the stylus pattern.

The playback control apparatus 600 is configured for performing the solution in any one of the preceding embodiments. Therefore, the apparatus has the technical effects described above, and details will not be repeated herein.

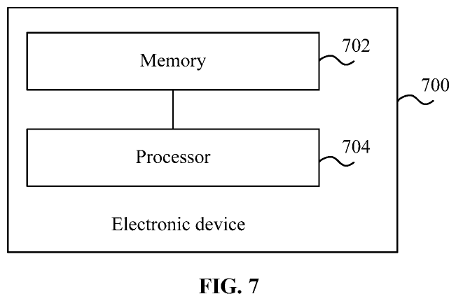

FIG. 7 illustrates a block diagram of an electronic device according to an embodiment of the present application.

As shown in FIG. 7, the electronic device 700 according to an embodiment of the present application includes at least one memory 702 and a processor 704 communicatively connected to the at least one memory 702, where the memory has instructions executable by the at least one processor 704 stored thereon, and the instructions are used for performing the solution in any one of the preceding embodiments. Therefore, the electronic device 700 has the same technical effects as those of the solution in any one of the preceding embodiments, and details will not be repeated herein.

The electronic devices of the embodiments of the present application exist in various forms, including but not limited to:
(1) mobile communication devices: this kind of devices is characterized by mobile communication functions, and their main goal is to provide voice and data communication; terminals of such a kind include smart phones (such as iPhone), multimedia phones, functional phones, and low-end phones;
(2) ultra-mobile personal computer devices: this kind of devices belongs to the category of personal computers, and they have computing and processing functions and generally have the characteristics of mobile Internet; terminals of such a kind include personal digital assistant (PDA) devices, mobile Internet device (MID) devices and ultra-mobile personal computer (UMPC) devices, such as iPad;
(3) portable entertainment devices: this kind of devices can display and play multimedia content; devices of such a kind include audio and video players (such as iPod), handheld game consoles, electronic books, smart toys and portable vehicle navigation devices;
(4) other electronic devices having a data interaction function.

In addition, an embodiment of the present application further provides a computer-readable storage medium having computer-executable instructions stored thereon, where the computer-executable instructions are used for performing the method flow in any one of the preceding embodiments.

The technical solutions of the present application are described above in detail in conjunction with drawings, and through the technical solutions of the present application, the user can read the multi-media file in richer and more vivid manners.

It is to be understood that although terms such as first and second may be used herein to describe designated storage locations, these designated storage locations are not to be limited by these terms. These terms are used to distinguish designated storage locations from each other. For example, without departing from the scope of the embodiments of the present application, the first designated storage location may be referred to as the second designated storage location, and similarly, the second designated storage location may be referred to as the first designated storage location.

Depending on the context, the word “if” as used herein may be interpreted as “when”, “during”, “in response to determining that”, or “in response to detecting that”. Similarly, depending on the context, the phrases “if it is determined that” or “if it is detected that (stated conditions or events)” can be interpreted as “when it is determined that”, “in response to determining that”, “when it is detected that (stated conditions or events)” or “in response to detecting that (stated conditions or events)”.

It is to be understood that the systems, apparatuses and methods disclosed in some embodiments of the present application may be implemented in other manners. For example, the apparatus embodiments described above are merely illustrative. For example, the divisions of units are merely divisions of logical functions which may be divided by other ways in the actual implementation. For example, the various elements or components may be combined or integrated in another system or certain features may be omitted, or not implemented. In addition, other items shown or discussed as coupled, directly coupled or communicating with each other may be indirectly coupled or communicating through some interface, apparatus or device whether electrically, mechanically, or otherwise.

In addition, various functional units in each embodiment of the present application may be integrated into one processing unit, each unit may be physically display separately, or two or more units may be integrated into one unit. The integrated unit may be implemented in the form of hardware or may be implemented in the form of hardware and software function units.

The integrated unit implemented in the form of software functional units may be stored in a computer-readable storage medium. The software functional units are stored in a storage medium, and the storage medium includes a number of instructions for enabling a computer apparatus (which may be a personal computer, a server or a network apparatus) or a processor to perform part of steps of the method described in each embodiment of the present application. The preceding storage medium includes a USB flash disk, a mobile hard disk, a read-only memory (ROM), a random access memory (RAM), a magnetic disk, an optical disk or another medium capable of storing program codes.

1. A playback control method, comprising:
displaying a record analog image of a multi-media file in a playback process of the multi-media file, wherein the record analog image has a sound groove pattern; and
displaying a marker of a playback progress of the multi-media file on the sound groove pattern according to the playback progress of the multi-media file, wherein a location of the marker on the sound groove pattern is configured for reflecting the playback progress.

2. The playback control method according to claim 1, further comprising:
obtaining the sound groove pattern by mapping an audio waveform of the multi-media file onto a sound groove track.

3. The playback control method according to claim 1, further comprising:
acquiring a location selection operation for the sound groove pattern; and
configuring a playback progress corresponding to a target location selected by the location selection operation on the sound groove pattern to a current playback progress of the multi-media file, and displaying a marker of the current playback progress at the target location.

4. The playback control method according to claim 1, wherein the displaying a record analog image of a multi-media file comprises:
displaying the obtained record analog image having the sound groove pattern; or
displaying a loading process of the sound groove pattern, wherein the loading process of the sound groove pattern is synchronized with a loading process of the multi-media file.

5. The playback control method according to claim 1, wherein the displaying the marker of the playback progress of the multi-media file on the sound groove pattern according to the playback progress of the multi-media file comprises:
dynamically displaying the marker of the playback progress on the sound groove pattern while playing the multi-media file, wherein the marker comprises a stylus pattern or a pickup pattern.

6. The playback control method according to claim 5, further comprising:
acquiring a rotational speed setting operation for the marker; and
wherein dynamically displaying the marker of the playback progress on the sound groove pattern comprises:
dynamically displaying the marker of the playback progress on the sound groove pattern according to a rotational speed set by the rotational speed setting operation, wherein the rotational speed corresponds to a playback speed of the multi-media file.

7. The playback control method according to claim 5, further comprising:
in a case where the marker comprises the stylus pattern, dynamically displaying a tone arm pattern while displaying the record analog image;
wherein the tone arm pattern is connected to the stylus pattern, and the stylus pattern is located at the target location corresponding to the current playback progress of the multi-media file on the sound groove pattern in a dynamic displaying process of the stylus pattern.

8. (canceled)

9. An electronic device, comprising at least one processor and a memory communicatively connected to the at least one processor;
wherein the memory has instructions executable by the at least one processor stored thereon, and the instructions are used for performing a playback control method, wherein the playback control method comprises:
displaying a record analog image of a multi-media file in a playback process of the multi-media file, wherein the record analog image has a sound groove pattern; and
displaying a marker of a playback progress of the multi-media file on the sound groove Pattern according to the playback progress of the multi-media file, wherein a location of the marker on the sound groove pattern is configured for reflecting the playback progress.

10. A non-transitory computer-readable storage medium having computer-executable instructions stored thereon, wherein the computer-executable instructions are used for performing a playback control method, wherein the playback control method comprises:
displaying a record analog image of a multi-media file in a playback process of the multi-media file, wherein the record analog image has a sound groove pattern; and
displaying a marker of a playback progress of the multi-media file on the sound groove pattern according to the playback progress of the multi-media file, wherein a location of the marker on the sound groove pattern is configured for reflecting the playback progress.

11. The electronic device according to claim 9, further comprising:
obtaining the sound groove pattern by mapping an audio waveform of the multi-media file onto a sound groove track.

12. The electronic device according to claim 9, further comprising:
acquiring a location selection operation for the sound groove pattern; and
configuring a playback progress corresponding to a target location selected by the location selection operation on the sound groove pattern to a current playback progress of the multi-media file, and displaying a marker of the current playback progress at the target location.

13. The electronic device according to claim 9, wherein the displaying a record analog image of a multi-media file comprises:
displaying the obtained record analog image having the sound groove pattern; or
displaying a loading process of the sound groove pattern, wherein the loading process of the sound groove pattern is synchronized with a loading process of the multi-media file.

14. The electronic device according to claim 9, wherein the displaying the marker of the playback progress of the multi-media file on the sound groove pattern according to the playback progress of the multi-media file comprises:
dynamically displaying the marker of the playback progress on the sound groove pattern while playing the multi-media file, wherein the marker comprises a stylus pattern or a pickup pattern.

15. The electronic device according to claim 14, further comprising:
acquiring a rotational speed setting operation for the marker; and
wherein dynamically displaying the marker of the playback progress on the sound groove pattern comprises:
dynamically displaying the marker of the playback progress on the sound groove pattern according to a rotational speed set by the rotational speed setting operation, wherein the rotational speed corresponds to a playback speed of the multi-media file.

16. The electronic device according to claim 14, further comprising:
in a case where the marker comprises the stylus pattern, dynamically displaying a tone arm pattern while displaying the record analog image;
wherein the tone arm pattern is connected to the stylus pattern, and the stylus pattern is located at the target location corresponding to the current playback progress of the multi-media file on the sound groove pattern in a dynamic displaying process of the stylus pattern.

17. The non-transitory computer-readable storage medium according to claim 10, further comprising:
obtaining the sound groove pattern by mapping an audio waveform of the multi-media file onto a sound groove track.

18. The non-transitory computer-readable storage medium according to claim 10, further comprising:
acquiring a location selection operation for the sound groove pattern; and
configuring a playback progress corresponding to a target location selected by the location selection operation on the sound groove pattern to a current playback progress of the multi-media file, and displaying a marker of the current playback progress at the target location.

19. The non-transitory computer-readable storage medium according to claim 10, wherein the displaying a record analog image of a multi-media file comprises:
displaying the obtained record analog image having the sound groove pattern; or
displaying a loading process of the sound groove pattern, wherein the loading process of the sound groove pattern is synchronized with a loading process of the multi-media file.

20. The non-transitory computer-readable storage medium according to claim 10, wherein the displaying the marker of the playback progress of the multi-media file on the sound groove pattern according to the playback progress of the multi-media file comprises:
dynamically displaying the marker of the playback progress on the sound groove pattern while playing the multi-media file, wherein the marker comprises a stylus pattern or a pickup pattern.
